(19) United States
(12) Patent Application Publication
(10) Pub. No.: US 2025/0124369 A1
(43) Pub. Date: Apr. 17, 2025

(54) SYSTEM AND METHOD FOR OPTIMIZING A NUMBER OF SESSIONS OF A MULTI-SESSION MEETING BASED ON AGENTS SKILL REQUIREMENT DURING A TIME-RANGE OF SCHEDUELED WORK-SHIFTS IN A CLOUD-BASED CONTACT CENTER

(71) Applicant: NICE LTD., Ra'anana (IL)

(72) Inventors: Vaibhav CHOBE, Pune (IN); Niranjan BAGADE, Pune (IN); Kanchan VASNANI, Niranjanpur (IN)

(21) Appl. No.: 18/380,915

(22) Filed: Oct. 17, 2023

(51) Int. Cl. G06Q 10/0631

(52) U.S. Cl. CPC G06Q 10/063112; G06Q 10/063118

(57) ABSTRACT

A computer-implemented method for optimizing a number of sessions of a multi-session meeting based on agents skill requirement during a time-range of scheduled work-shifts, in a cloud-based contact center. The computer-implemented method includes receiving a time-range of scheduled work-shifts, a maximum number of agents in each session of the multi-session meeting, one or more skill-types and a buffer-level for each skill-type, operating a schedule manager MS to provide scheduled work-shifts of agents in the time-range of scheduled work-shifts that include open slots and net staffing data of each skill-type, determining a total number of agents, calculating a lower-bound of sessions and an upper-bound of sessions, iteratively determining a number of sessions of the multi-session meeting and allocating the total number of agents to the determined number of sessions of the multi-session meeting until an optimal number of sessions of the multi-session meeting is reached.

### TECHNICAL FIELD

The present disclosure relates to the field of data analysis for optimizing a number of sessions of a multi-session meeting based on agents skill requirement during a time-range of scheduled work-shifts, in a cloud-based contact center.

### BACKGROUND

In current systems in contact centers, after agents schedules of work-shifts are generated, a user, such as a supervisor adds activities like team meetings or coaching sessions or compliance trainings to these schedules based on the contact center needs. These activities are either added manually by the supervisor on an individual agent schedule or by using a feature of a platform such as, Meeting Scheduler, where the meetings can be added for one or more agents at least one week in advance. When scheduling the meetings, there is an option to use the feature of flexible Meeting Scheduler where meetings are scheduled over a span of days for the agents, such that only one meeting is assigned to the agent under one request, and it is necessary to ensure that the contact center is adequately staffed to handle the customer calls by other agents, during the scheduled meetings.

Thus, currently the supervisor has to adjust the sessions of a multi-session meeting, manually after schedules of work-shifts have been generated to avoid a situation of understaffing in case there is no buffer added to cater to any on-demand requirements. There may be last-minute cancellation of sessions of the multi-session meeting due to a requirement of some agents that were assigned to the sessions, in case of any understaffing in the contact center, which may impact other agents schedules as well, because they were supposed to be part of those cancelled meetings.

Therefore, there is a need for a technical solution that will provide an optimal number of sessions of a multi-session meeting for a specified number of agents, such that there are not too many sessions with a few agents, which may waste the sessions host time and not too few sessions where each session includes a high number of agents to prevent understaffing of the contact center for that interval of time. Accordingly, there is a need for a technical solution that will optimize a number of sessions of a multi-session meeting based on agents skill requirement during a time-range of scheduled work-shifts, in a cloud-based contact center.

### SUMMARY

There is thus provided, in accordance with some embodiments of the present disclosure, a computer-implemented method for optimizing a number of sessions of a multi-session meeting based on agents skill requirement during a time-range of scheduled work-shifts, in a cloud-based contact center.

Furthermore, in accordance with some embodiments of the present disclosure, the computer-implemented method may include: (i) receiving via a User Interface (UI) of a webapp a time-range of scheduled work-shifts, a maximum number of agents in each session of the multi-session meeting, one or more skill-types and a buffer-level for each skill-type of the one or more skill-types; (ii) operating a schedule manager Microservice (MS) to provide: a. scheduled work-shifts of agents in the time-range of scheduled work-shifts that include open slots from a database of a plurality of agents with respective plurality of schedules of work-shifts thereon; and b. net staffing data net staffing data of each skill-type of the received one or more skill-types in each open slot in the scheduled work-shifts in the time-range of scheduled work-shifts.

Furthermore, in accordance with some embodiments of the present disclosure, the computer-implemented method may further include: (iii) determining a total number of agents in the time-range of scheduled work-shifts that include open slots; (iv) calculating a lower-bound of sessions and an upper-bound of sessions; (v) determining a number of sessions of the multi-session meeting based on agents skill requirement by calculating an average of the calculated lower-bound of sessions and the calculated upper-bound of sessions.

Furthermore, in accordance with some embodiments of the present disclosure, the computer-implemented method further includes (vi) allocating the total number of agents in the time-range of scheduled work-shifts that include open slots to the determined number of sessions of the multi-session meeting based on agents skill requirement during the received time-range of scheduled work-shifts.

Furthermore, in accordance with some embodiments of the present disclosure, when the determined number of sessions of the multi-session meeting based on agents skill requirement is above a preconfigured percentage of the calculated upper-bound of sessions, decreasing the calculated upper-bound by a binary search algorithm and performing operations (v)-(vi), and when the determined number of sessions of the multi-session meeting based on agents skill requirement is below or equal to the preconfigured percentage of the calculated upper-bound of sessions increasing the calculated lower-bound by the binary search algorithm and performing operations (v)-(vi).

Furthermore, in accordance with some embodiments of the present disclosure, the computer-implemented method further includes sending a notification to each agent in the total number of agents with session date and time and storing each updated schedule in the database of a plurality of agents with respective plurality of schedules of work-shifts thereon.

Furthermore, in accordance with some embodiments of the present disclosure, the computer-implemented method further includes updating each schedule of each agent of the determined total number of agents with session date and time.

Furthermore, in accordance with some embodiments of the present disclosure, the calculating of lower-bound of sessions may be operated by allocating for each open slot in the scheduled work-shifts in the time-range of scheduled work-shifts the received maximum number of agents in each session of the multi-session meeting and meeting the received buffer-level for each skill-type of the one or more skill-types based on net staffing data of each skill-type for the open slot. The calculating of upper-bound of sessions may be operated by allocating for each open slot in the scheduled work-shifts in the time-range of scheduled work-shifts a preconfigured percentage of the received maximum number of agents in each session of the multi-session meeting of skill-based agents and meeting the received buffer-level for each skill-type of the one or more skill-types based on net staffing data for the open slot.

Furthermore, in accordance with some embodiments of the present disclosure, the determining of the total number of agents in the time-range of scheduled work-shifts that include open slots may be based on preferences thereof.

Furthermore, in accordance with some embodiments of the present disclosure, the allocating of the total number of agents to the determined number of sessions may be operated by using a greedy algorithm and round-robin method for selecting each agent for each session in the number of sessions of the multi-session meeting.

Furthermore, in accordance with some embodiments of the present disclosure, the allocating of the total number of agents in the time-range of scheduled work-shifts that include open slots to the determined number of sessions of the multi-session meeting based on agents skill requirement may be random.

There is further provided, in accordance with some embodiments of the present disclosure, a computerized-system for optimizing a number of sessions of a multi-session meeting based on agents skill requirement during a time-range of scheduled work-shifts, in a cloud-based contact center.

Furthermore, in accordance with some embodiments of the present disclosure, the computerized-system may include a processor, a memory including a database of a plurality of agents with respective plurality of schedules of work-shifts thereon, a User Interface (UI) of a webapp; and a schedule manager Microservice (MS).

Furthermore, in accordance with some embodiments of the present disclosure, the processor may be configured to: (i) receive via a User Interface (UI) of a webapp a time-range of scheduled work-shifts, a maximum number of agents in each session of the multi-session meeting, one or more skill-types and a buffer-level for each skill-type of the one or more skill-types: (ii) operate a schedule manager Microservice (MS) to provide a. scheduled work-shifts of agents in the time-range of scheduled work-shifts that include open slots from a database of a plurality of agents with respective plurality of schedules of work-shifts thereon; and b. net staffing data of each skill-type of the received one or more skill-types in each open slot.

Furthermore, in accordance with some embodiments of the present disclosure, the processor may be further configured to: (iii) determine a total number of agents in the time-range of scheduled work-shifts that include open slots; (iv) calculate a lower-bound of sessions and an upper-bound of sessions; (v) determine a number of sessions of the multi-session meeting based on agents skill requirement by calculating an average of the calculated lower-bound of sessions and the calculated upper-bound of sessions; and (vi) allocate the total number of agents in the time-range of scheduled work-shifts that include open slots to the determined number of sessions of the multi-session meeting based on agents skill requirement during the received time-range of scheduled work-shifts.

Furthermore, in accordance with some embodiments of the present disclosure, when the determined number of sessions of the multi-session meeting based on agents skill requirement is above a preconfigured percentage of the calculated upper-bound of sessions, decreasing the calculated upper-bound by a binary search algorithm and performing operations (v)-(vi), and when the determined number of sessions of the multi-session meeting based on agents skill requirement is below or equal to the preconfigured percentage of the calculated upper-bound of sessions increasing the calculated lower-bound by the binary search algorithm and performing operations (v)-(vi).

### BRIEF DESCRIPTION OF THE DRAWINGS

FIGS. 1A-1B schematically illustrate a high-level diagram of a system for optimizing a number of sessions of a multi-session meeting based on agents skill requirement during a time-range of scheduled work-shifts, in a cloud-based contact center, in accordance with some embodiments of the present disclosure;

FIGS. 2A-2C are a high-level workflow of computer-implemented method for optimizing a number of sessions of a multi-session meeting based on agents skill requirement during a time-range of scheduled work-shifts, in a cloud-based contact center, in accordance with some embodiments of the present disclosure;

FIG. 3 is a screenshot depicting a user interface to schedule multi-session meeting based on agents skill requirement during a time-range of scheduled work-shifts, in accordance with some embodiments of the present disclosure;

FIG. 4 is a screenshot depicting a weekly view of agents scheduled work-shifts and two sessions of a multi-session meeting, in accordance with some embodiments of the present disclosure;

FIGS. 5A-5B are screenshots depicting a daily view of the agents scheduled work-shifts and sessions of a multi-session meeting, in accordance with some embodiments of the present disclosure;

FIG. 6 shows a table with several options of numbers of multi-session meeting, in accordance with some embodiments of the present disclosure;

FIG. 7 illustrates a selection of an optimal number of multi-session meeting, in accordance with some embodiments of the present disclosure; and

FIG. 8 shows components of a Workforce Management (WFM) scheduling system and workflow, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current systems in contact centers, once agents schedules of work-shifts are generated, the user, such as supervisor, may add activities like team meetings or coaching sessions or compliance trainings to these scheduled work-shifts based on the contact center's needs. These meetings are either added manually by the supervisor on individual agent's schedule or by using a feature of a webapp, such as Meeting Scheduler where the sessions of a multi-session meetings can be added for one or more agents at least one week in advance.

When scheduling the meetings using the feature of flexible Meeting Scheduler where Meetings are scheduled over a span of days for the agents, such that only one meeting is assigned to the agent under one request, it is necessary to ensure the contact center is adequately staffed to handle the customer calls. An optimal number of sessions of a multi-session meeting should be created, i.e., neither too many sessions with a few agents in each session as may waste the time of the host of the sessions and nor too few sessions with a high number of agents in each session which may cause understaffing of the contact center for the time interval of the scheduled session.

Therefore, there is a need for system and method for optimizing a number of sessions of a multi-session meeting based on agents skill requirement during a time-range of scheduled work-shifts, in a cloud-based contact center.

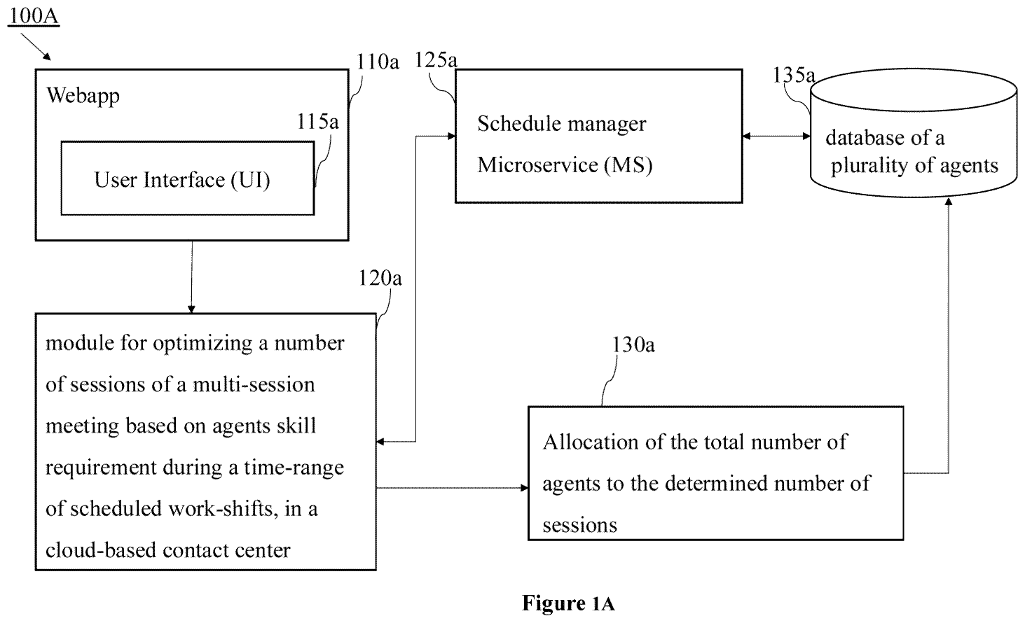

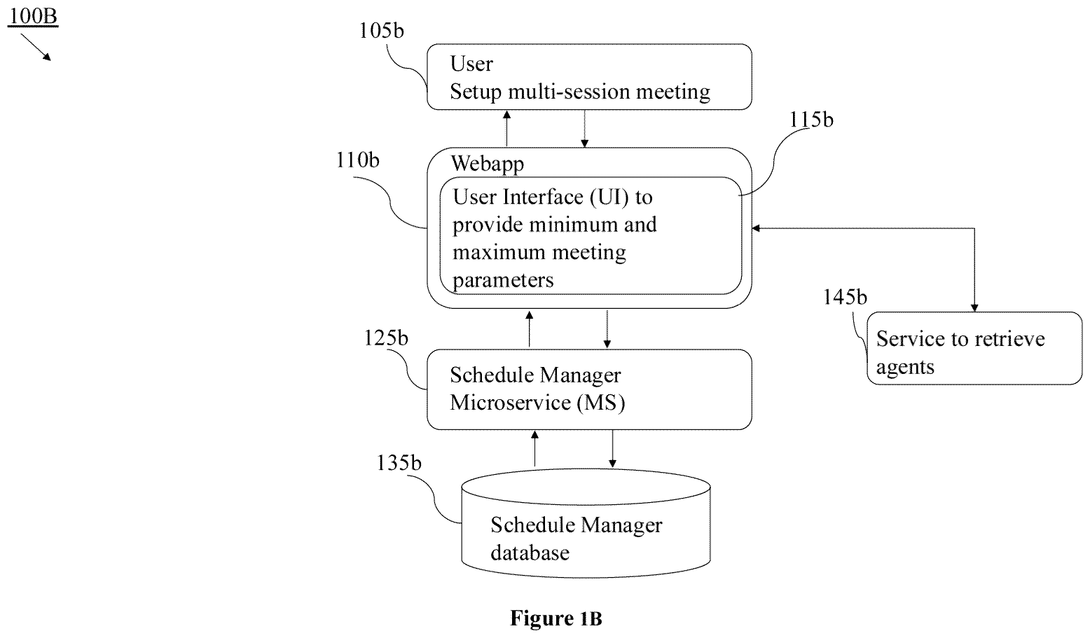

FIG. 1A schematically illustrates a high-level diagram of a system 100A for optimizing a number of sessions of a multi-session meeting based on agents skill requirement during a time-range of scheduled work-shifts of agents, in a cloud-based contact center, in accordance with some embodiments of the present disclosure.

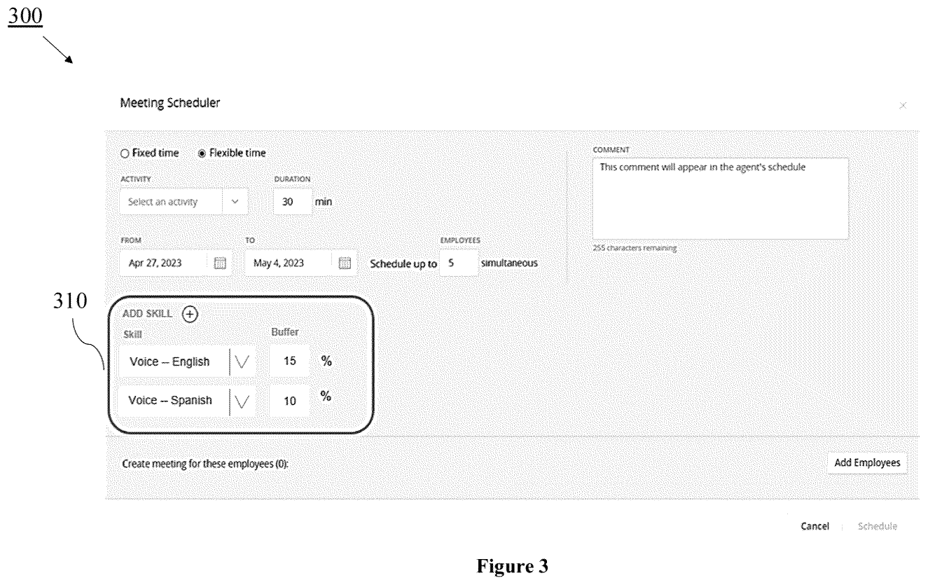

According to some embodiments of the present disclosure, in a system, such as system 100A, an optimal number of sessions of a multi-session meeting may be created after a user, such as a supervisor may provide a time-range of scheduled work-shifts, a maximum number of agents in each session of the multi-session meeting, one or more skill-types and a buffer-level for each skill-type of the one or more skill-types, as shown for example, in a screenshot depicting a user interface to schedule multi-session meeting based on agents skill requirement during a time-range of scheduled work-shifts 300 in FIG. 3.

According to some embodiments of the present disclosure, at the time of scheduling a multi-session meeting, the supervisor may use a UI 115a of a webapp 110a, such as Meeting Scheduler, to select skill type of the agents which are required for the multi-session meeting and to add a percentage buffer, i.e., buffer-level against them. The buffer-level may be considered against the number of agents having the skill-type when scheduling the sessions of the multi-session meeting in the scheduled work-shifts of the agents, such that the scheduled sessions with agents having the skill-type may not leave the contact center with a number of agents with that skill-type below the buffer-level. The skill-type may be for example, voice calls in English, voice calls in Spanish, voice calls in Hindi, English chat, Spanish chat, email, and the like. The buffer-level may be a preconfigured percentage of agents from the number of agents having the skill-type.

According to some embodiments of the present disclosure, parameters, such as a time-range of scheduled work-shifts, a maximum number of agents in each session of the multi-session meeting, one or more skill-types and a buffer-level for each skill-type of the one or more skill-types, may be received via the UI 115a of the webapp 110a. The parameters may be forwarded to a module, such as module 120a for optimizing a number of sessions of a multi-session meeting based on agents skill requirement during a time-range of scheduled work-shifts, in a cloud-based contact center.

According to some embodiments of the present disclosure, the module 120a for optimizing a number of sessions of a multi-session meeting based on agents skill-type requirement during a time-range of scheduled work-shifts, in a cloud-based contact center, may operate a Microservice (MS), such as schedule manager MS 125a to provide a. scheduled work-shifts of agents in the time-range of scheduled work-shifts that include open slots; and b. net staffing data of each skill-type of the received one or more skill-types in each open slot in the scheduled work-shifts in the time-range of scheduled work-shifts.

According to some embodiments of the present disclosure, for example, an open slot may be a time interval e.g., 15 minutes within an agent schedule work-shift in which the agent is available to take customer requests such as calls or chats and the like. For a given time interval, the requirement of a given skill-type may be specified e.g., five agents are needed who can handle voice calls in English. Based on the scheduled work-shifts that have been previously generated, six agents may be assigned during that time interval. Hence, the net staffing for that time interval, i.e., open slot may be overstaffed by one agent.

According to some embodiments of the present disclosure, the net staffing data may include net staffing data for the one or more skill-types per each open slot in the scheduled work-shifts in the time-range of scheduled work-shifts. The scheduled work-shifts in the time-range of scheduled work-shifts that include open slots may be retrieved from a database, such as database of a plurality of agents 135a having respective plurality of schedules of work-shifts thereon.

According to some embodiments of the present disclosure, a total number of agents in the time-range of scheduled work-shifts that include open slots may be determined and a lower-bound of sessions and an upper-bound of sessions may be calculated. The total number of agents may be determined by selecting all agents in the time-range of scheduled work-shifts that include open slots.

According to some embodiments of the present disclosure, a number of sessions of the multi-session meeting based on agents skill requirement may be determined by calculating an average of the calculated lower-bound of sessions and the calculated upper-bound of sessions.

According to some embodiments of the present disclosure, for example, when the lower-bound is 5 sessions of the multi-session meeting and the upper-bound is 10 sessions of the multi-session meeting then, the determined number of sessions of the multi-session meeting may be 7.5 sessions.

According to some embodiments of the present disclosure, when the determined number of sessions of the multi-session meeting based on agents skill requirement e.g., 7.5 may be above a preconfigured percentage of the calculated upper-bound number of sessions, e.g., 60% of 10 which is the upper-bound e.g., 6, then decreasing the calculated upper-bound by a binary search algorithm and determining the number of sessions of the multi-session meeting based on agents skill requirement by calculating an average of the calculated lower-bound of sessions and the calculated upper-bound of sessions.

According to some embodiments of the present disclosure, decreasing the calculated upper-bound by a binary search algorithm may include setting the upper-bound to the average of the lower-bound and upper-bound.

According to some embodiments of the present disclosure, for example, when the lower-bound is 5 sessions of the multi-session meeting and the calculated upper-bound is 7.5 sessions of the multi-session meeting then (5+6)/2=5 (rounded off).

According to some embodiments of the present disclosure, in yet another example, when the lower-bound number of meetings is 5 and it gives 10% overstaffing, and the upper-bound number of meetings is 20 and gives 70% overstaffing, then in the next iteration of the binary search the number of sessions of the multi-session meeting may be set to (5+20)/2=12 (rounded off). When 12 sessions of the multi-session meeting give 50% over staffing then in the next iteration, the number of sessions of the multi-session meeting may be set to (5+12)/2=8 and the 8 sessions may reach the desired percentage of adequate staffing of 29% then the binary search algorithm may stop. Otherwise, it may continue.

According to some embodiments of the present disclosure, the allocating of the total number of agents during the time-range of scheduled work-shifts that include open slots to the determined number of sessions of the multi-session meeting based on agents skill requirement may be random. Meaning, each session of the multi-session meeting, may include randomly selected number of agents from the total number of agents. The selected number of agents may be the total number of agents divided by the determined number of sessions of the multi-session meeting. Each session of the multi-session meeting may be scheduled by randomly selecting an open-slot in the provided scheduled work-shifts in the time-range of scheduled work-shifts that include open slots.

According to some embodiments of the present disclosure, when the determined number of sessions of the multi-session meeting based on agents skill requirement is below or equal to the preconfigured percentage of the calculated upper-bound of sessions for example, when the lower-bound is 2 sessions and the upper-bound is 10 sessions then the average may be 6 sessions which equals 60% of the 10 sessions, then, increasing the calculated lower-bound by the binary search algorithms and determining the number of sessions of the multi-session meeting based on agents skill requirement by calculating an average of the calculated lower-bound of sessions and the calculated upper-bound of sessions. The increasing of the calculated lower-bound may include setting the lower-bound to the average of the lower-bound and upper-bound and then recalculating the average of the updated lower-bound and the upper-bound.

According to some embodiments of the present disclosure, the total number of agents in the time-range of scheduled work-shifts that include open slots may be allocated to the determined number of sessions of the multi-session meeting based on agents skill requirement.

According to some embodiments of the present disclosure, a notification may be sent to each computer-device of each agent in the total number of agents with the respective allocated session date and time and each updated schedule of work-shift may be stored in the database of a plurality of agents with respective plurality of schedules of work-shifts thereon.

According to some embodiments of the present disclosure, the details of the scheduled sessions of the multi-session meeting may be sent to a user, such as a supervisor.

According to some embodiments of the present disclosure, each schedule of each agent of the determined total number of agents may be updated with the allocated session date and time.

According to some embodiments of the present disclosure, the calculating of lower-bound of sessions may be operated by allocating for each open slot in the scheduled work-shifts in the time-range of scheduled work-shifts the received maximum number of agents in each session of the multi-session meeting of skill-based agents. The open slots of the agents scheduled work-shifts are parsed sequentially from the shift start time.

According to some embodiments of the present disclosure, the one or more skill-types may be sorted as a prerequisite for the binary search.

According to some embodiments of the present disclosure, the calculating of the upper-bound of sessions may be operated by allocating for each randomly selected open slot in the scheduled work-shifts in the time-range of scheduled work-shifts a preconfigured percentage of the received maximum number of agents in each session of the multi-session meeting of skill-based agents and taking into consideration the received buffer-level for each skill-type of the one or more skill-types based on net staffing data for the open slot. Taking into consideration the buffer-level for each skill-type means that number of agents of the net staffing for the open slot in addition to the buffer-level may remain in the contact center and not scheduled the session.

According to some embodiments of the present disclosure, the total number of agents may be allocated iteratively by using a greedy algorithm and round-robin method for selecting each agent for each session in the number of sessions of the multi-session meeting.

According to some embodiments of the present disclosure, the round robin method within the greedy algorithm may be used to minimize understaffing or overstaffing of any skill-type. For example, when there are 30 agents of each skill type where skills are Spanish, English, and Hindi, a supervisor may set maximum 10 agents in a session of a multi-session meeting. When all 10 agents are selected from Spanish and none from English, and Hindi, the contact center may be overstaffed for English and Hindi skill and understaffed for Spanish. But when there are 3 agents from Spanish, 3 agents from English and 4 agents from Hindi, understaffing for Spanish may be reduced as well as overstaffing for English, and Hindi.

FIG. 1B schematically illustrates a high-level diagram of a system 100B for optimizing a number of sessions of a multi-session meeting based on agents skill requirement during a time-range of scheduled work-shifts, in a cloud-based contact center, in accordance with some embodiments of the present disclosure.

According to some embodiments of the present disclosure, a user may setup multi-session meeting 105b via a UI 115b to provide minimum and maximum meeting parameters in a webapp 110b.

According to some embodiments of the present disclosure, the user, such as a supervisor may initiate a flexible multi-session meeting with a plurality of parameters. The plurality of parameters may include the duration of each session of the multi-session meeting, a time-range of scheduled work-shifts, a maximum number of agents in each session of the multi-session meeting, one or more skill-types and a buffer-level for each skill-type of the one or more skill-types, for example as shown in FIG. 3.

According to some embodiments of the present disclosure, based on the plurality of parameters, a schedule manager Microservice (MS) 125b may be operated to provide scheduled work-shifts in the time-range of scheduled work-shifts that include open slots from a database of a plurality of agents with a respective plurality of schedules of work-shifts thereon; and b. net staffing data thereof.

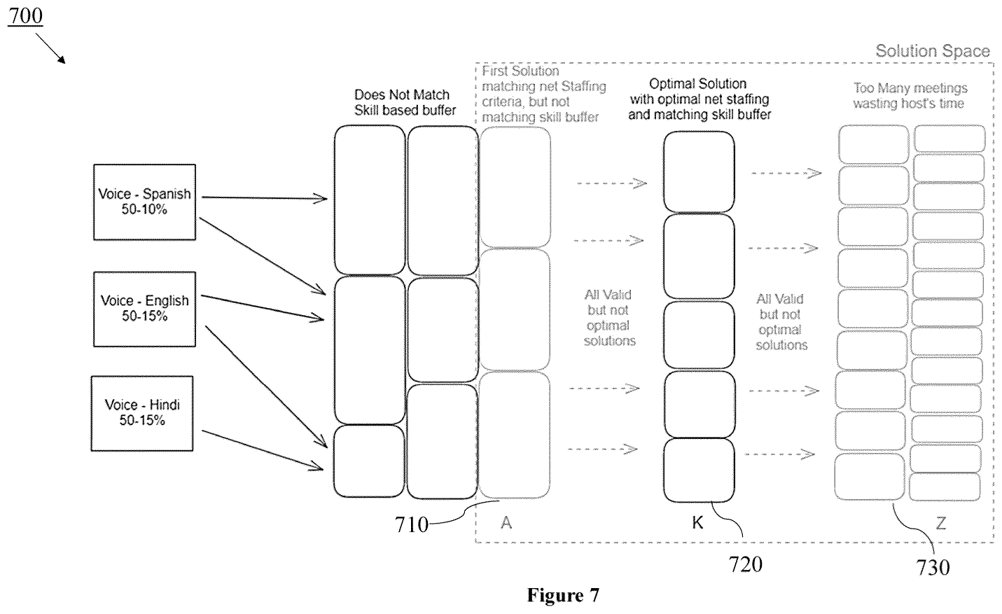

According to some embodiments of the present disclosure, initially a first base solution may be operated to find the lower bound of number of sessions of the multi-session meeting, as shown for example, by element 710 in FIG. 7. The lower-bound of number of sessions of the multi-session meeting may be determined by the total number of agents with the received one or more skill-types having the received one or more skill-types divided by the received maximum number of agents in each session of the multi-session meeting. The lower-bound number of sessions of the multi-session meeting is not taking into account the buffer-level for each skill-type and therefore such an allocation to the lower-bound number of sessions may not be adequate for a sudden spike in inbound incoming interactions. The lower-bound number of sessions of the multi-session meeting may indicate a minimum number of sessions for the determined total number of agents having the required one or more skill-types but doesn't consider a buffer for each skill-type.

According to some embodiments of the present disclosure, an upper-bound number of sessions may be calculated which may be a preconfigured percentage of the received maximum number of agents in each session of the multi-session meeting of skill-based agents, e.g., 20% of the maximum number of agents per session. The upper-bound number of sessions may be a higher number of sessions than the lower-bound because only the preconfigured percentage of the received maximum number of agents may be potentially allocated to each session. For example, as shown by element 730 in FIG. 7.

According to some embodiments of the present disclosure, for example, when the net staffing data for an open slot in the time-range of scheduled work-shifts indicates that there should be at least 10 agents having the skill-type of “Debit Card” related calls and the user has selected for that skill-type a buffer-level of 2% which means that during that open slot there should be a total of 12 agents.

According to some embodiments of the present disclosure, the total number of agents may be the number of agents having the required one or more skill-types during the provided time range of scheduled work-shifts with an open slot. Optionally, the total number may be selected by the user, such as the supervisor.

According to some embodiments of the present disclosure, the system, such as system 100B may fetch the required details of the agents which are eligible to be scheduled to the multi-session meeting, such as agent schedules of work-shifts during the time range, open slots, and net staffing data per each open slot in the scheduled work-shifts in the time-range of scheduled work-shifts.

According to some embodiments of the present disclosure, the skill-types of the agents may be sorted and their associated agent allocation.

According to some embodiments of the present disclosure, the open slots for the sessions of the multi-session meeting may be selected out of the total open slots in the scheduled work-shifts in the time-range of scheduled work-shifts by implementing the greedy algorithm to allocate agents to different sessions in such a way that the maximum number of agents are allocated from each skill-type to a specific meeting.

According to some embodiments of the present disclosure, the number of agents per each session may be determined to be a preconfigured percentage from the maximum number of agents which has been received from the user. For example, 20% from the maximum number of agents received from the user. Then, the upper-bound number of sessions may be calculated by the total number of agents divided by the number of agents per each session.

According to some embodiments of the present disclosure, by using the greedy algorithm, and taking into account the upper-bound of sessions agent may greedily be assigned from each skill-type such that the contact center may not become understaffed for a given skill-type, few agents may be chosen from different skill-types, such that the overall understaffing may be reduced. According to some embodiments of the present disclosure, the number of sessions of the multi-session meeting may be determined to be between the lower-bound number of sessions and the upper-bound number of sessions. The determined number of sessions may be calculated by using the binary search. In each iteration of the binary search the number of slots that is average of the upper bound and lower bound solution may be computed.

According to some embodiments of the present disclosure, when the average of the lower-bound number of sessions and the upper-bound session is more than a preconfigured number, for example, 29% of the upper-bound number of sessions, the upper-bound number of sessions may be decreased and the average of lower-bound number of sessions and the upper-bound number of sessions may be recalculated.

According to some embodiments of the present disclosure, when the average is less than the preconfigured percentage of the upper-bound number of sessions, the lower-bound number of sessions may be increased and then the number of sessions may be calculated as the average of the lower-bound session and the upper-bound session. The increasing of the calculated lower-bound may include setting the lower-bound to the average of the lower-bound and upper-bound and then recalculating the average of the updated lower-bound and the upper-bound.

According to some embodiments of the present disclosure, the total number of agents may be allocated to the number of sessions and the allocation may be evaluated. This iterative process of updating the upper-bound or the lower-bound and then calculating the average of the lower-bound number of sessions and upper-bound number of sessions and then allocating the agents may come to a halt when optimal number of sessions for the multi-session meeting are identified. The optimal number may be determined by computing in each iteration how well the agent allocation is managed without disturbing any forecast requirements. For example, the optimal number of sessions may be 29%+/−5% the upper-bound.

According to some embodiments of the present disclosure, for example, in the first iteration, the number of sessions may be 10 which may make the contact center may be overstaffed, then a binary search may be implemented and in the second iteration, when the number of sessions is 7 then the contact center may be still overstaffed. A third iteration of the binary search may be operated which may consider the number of sessions to be 4 sessions which may be indicated as adequately staffed.

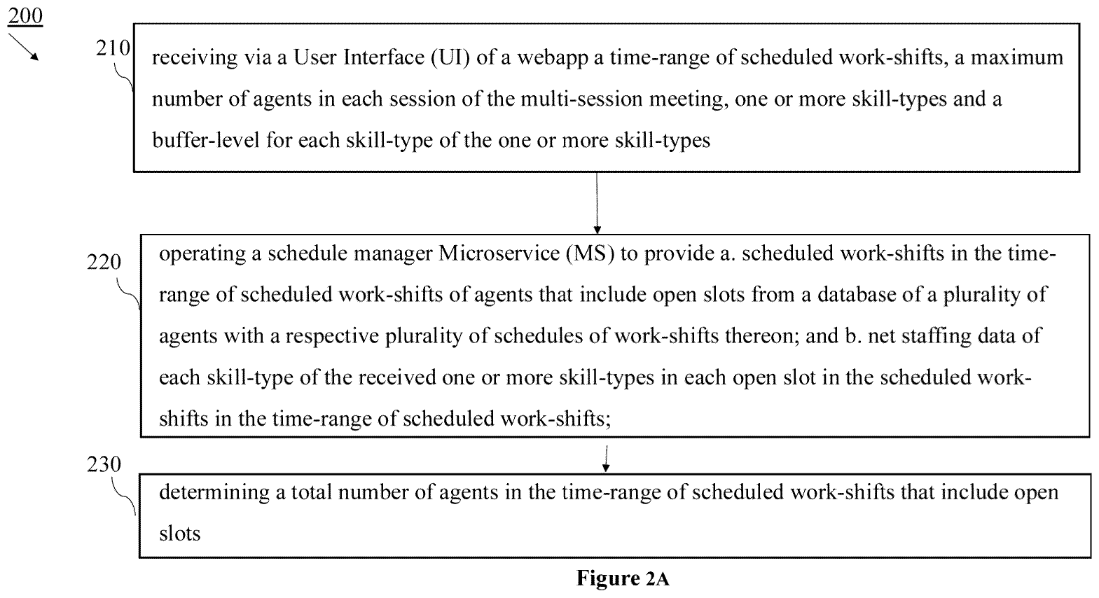

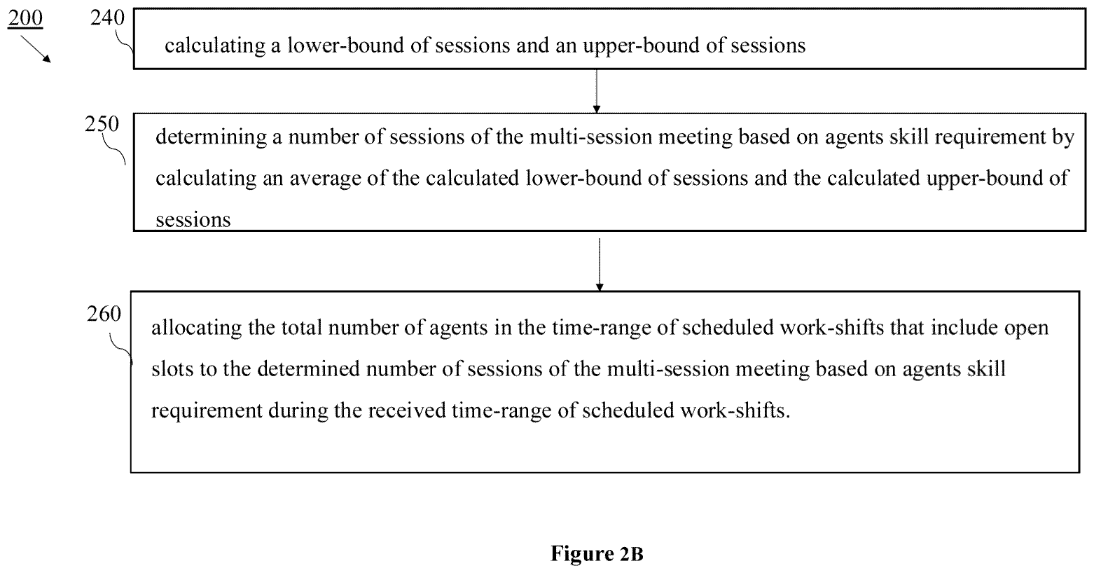

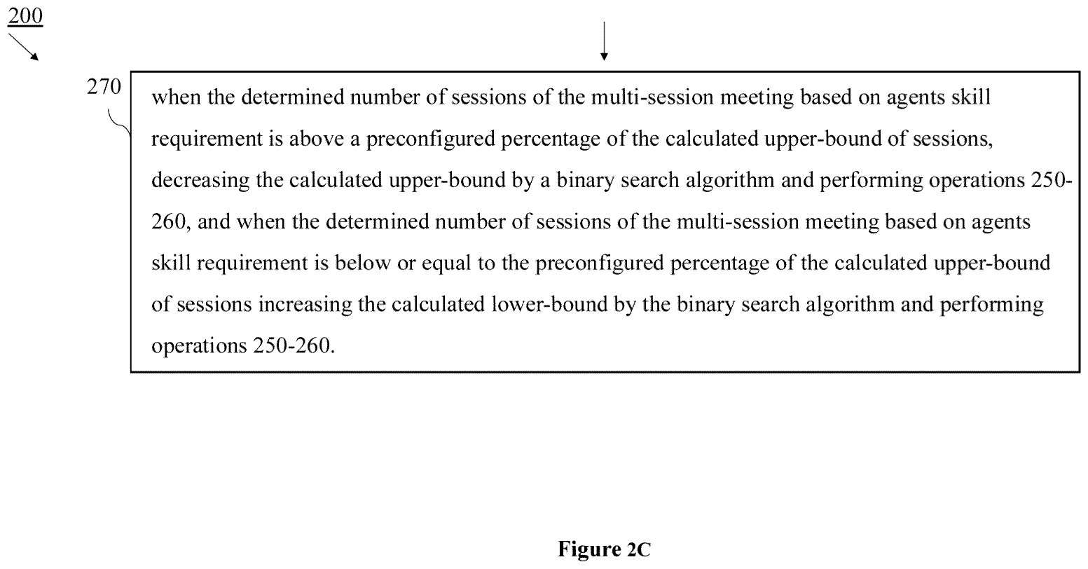

FIGS. 2A-2C are a high-level workflow of computer-implemented method 200 for optimizing a number of sessions of a multi-session meeting based on agents skill requirement during a time-range of scheduled work-shifts, in a cloud-based contact center, in accordance with some embodiments of the present disclosure.

According to some embodiments of the present disclosure, operation 210 comprising receiving via a User Interface (UI) of a webapp a time-range of scheduled work-shifts, a maximum number of agents in each session of the multi-session meeting, one or more skill-types and a buffer-level for each skill-type of the one or more skill-types.

According to some embodiments of the present disclosure, operation 220 comprising operating a schedule manager Microservice (MS) to provide a. scheduled work-shifts in the time-range of scheduled work-shifts that include open slots from a database of a plurality of agents with respective plurality of schedules of work-shifts thereon; and b. net staffing data of each skill-type of the received one or more skill-types in each open slot in the scheduled work-shifts in the time-range of scheduled work-shifts.

According to some embodiments of the present disclosure, operation 230 comprising determining a total number of agents in the time-range of scheduled work-shifts that include open slots.

According to some embodiments of the present disclosure, operation 240 comprising calculating a lower-bound of sessions and an upper-bound of sessions.

According to some embodiments of the present disclosure, operation 250 comprising determining a number of sessions of the multi-session meeting based on agents skill requirement by calculating an average of the calculated lower-bound of sessions and the calculated upper-bound of sessions.

According to some embodiments of the present disclosure, operation 260 comprising allocating the total number of agents in the time-range of scheduled work-shifts that include open slots to the determined number of sessions of the multi-session meeting based on agents skill requirement during the received time-range of scheduled work-shifts.

According to some embodiments of the present disclosure, operation 270 comprising when the determined number of sessions of the multi-session meeting based on agents skill requirement is above a preconfigured percentage of the calculated upper-bound of sessions, decreasing the calculated upper-bound by a binary search algorithm and performing operations 250-260, and when the determined number of sessions of the multi-session meeting based on agents skill requirement is below or equal to the preconfigured percentage of the calculated upper-bound of sessions increasing the calculated lower-bound by the binary search algorithm and performing operations 250-260.

FIG. 3 is a screenshot depicting a user interface 300 to schedule multi-session meeting based on agents skill requirement during a time-range of scheduled work-shifts, in accordance with some embodiments of the present disclosure.

According to some embodiments of the present disclosure, a flexible meeting scheduler is a feature which allows ‘X’ number of sessions of a multi-session meeting to be scheduled among ‘Y’ number of agents, such that no agent is repeated in more than one session of the multi-session meeting. For example, when a supervisor wants to conduct a training session about “Using a newly introduced feature”, it is not feasible to schedule one training session for all the agents in the contact center as the contact center would be acutely understaffed for that interval of time of the session.

According to some embodiments of the present disclosure, therefore, by using the flexible meeting scheduler feature, multiple sessions of the same meeting may be scheduled at different time intervals with agents having a common skill-type participating in each session.

According to some embodiments of the present disclosure, the flexible meeting scheduler may be implementing a computer-implemented method, such as computer-implemented method 200 in FIGS. 2A-2C as shown in system 100A in FIG. 1A or in system 100B in FIG. 1. One or more skill types and a buffer-level for each skill-type 310 may be added. The selected one or more skill-types may be for example, voice calls in English with a buffer-level of 15% and voice calls in Spanish with a buffer-level of 10%. The selected one or more-skills and corresponding buffer-level may indicate the required agents having the one or more skills for the multi-session meeting and the buffer-level that should be kept in the contact center during the scheduled sessions of the multi-session meeting.

According to some embodiments of the present disclosure, the selected one or more skill-types relates to skill-types which are critical for the contact center and the total number of agents are all agents in the contact center that have an open slot in during the scheduled work-shifts in the selected range of time. The buffer-level may indicate the percentage of agents in addition to the net-staffing data required to be available for the selected skill-type during the time interval of each session of the multi-session meeting. This may ensure that critical skill-types to the contact center do not go understaffed due to any unexpected volume of contacts arriving.

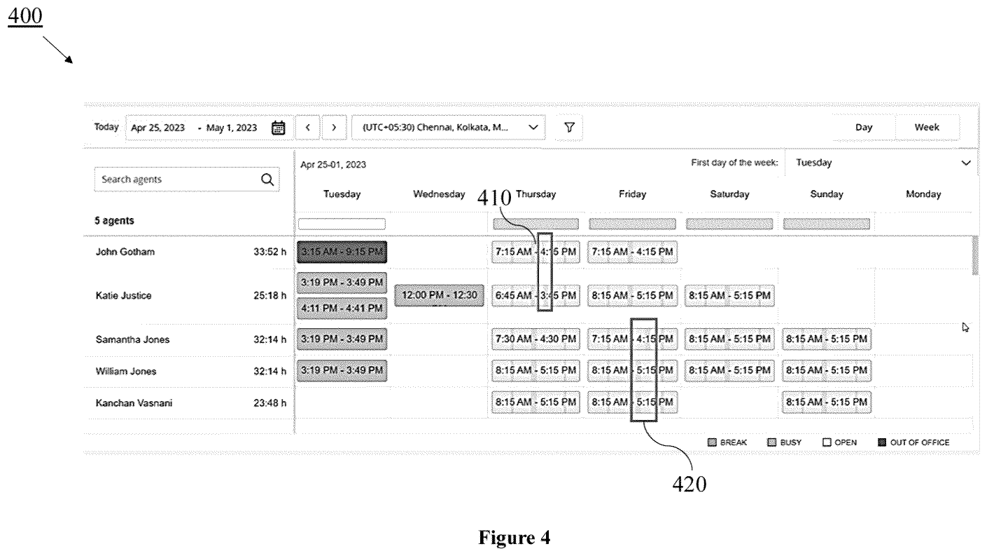

FIG. 4 is a screenshot depicting a weekly view 400 of agents scheduled work-shifts and two sessions of a multi-session meeting, in accordance with some embodiments of the present disclosure.

According to some embodiments of the present disclosure, element 410 shows one session of two agents scheduled in the schedule of work-shift of the agents and element 420 shows a second session of three agents scheduled in the schedule of work-shift of the agents.

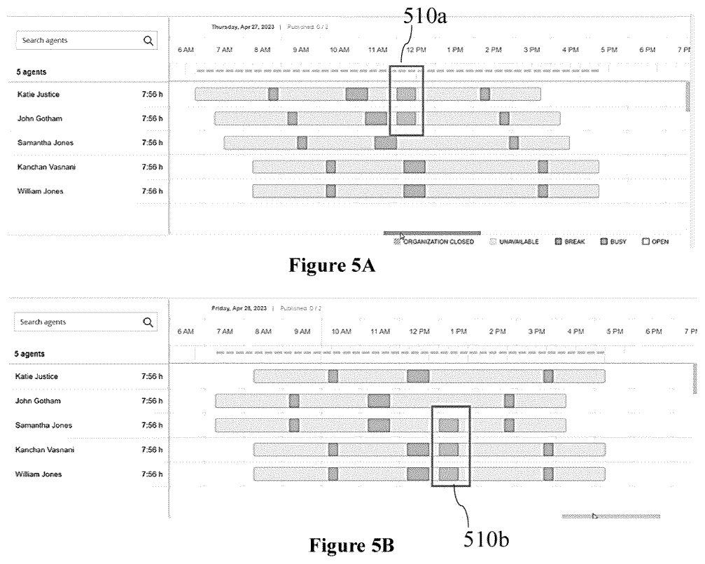

FIGS. 5A-5B are screenshots depicting a daily view of the agents scheduled work-shifts and sessions of a multi-session meeting, in accordance with some embodiments of the present disclosure.

According to some embodiments of the present disclosure, daily view of the agents scheduled work-shifts of the scheduled session of two agents 410 in FIG. 4 is shown by element 510a in FIG. 5A.

According to some embodiments of the present disclosure, the daily view of the agents scheduled work-shifts of the scheduled session of three agents 420 in FIG. 4 is shown by element 510b in FIG. 5B.

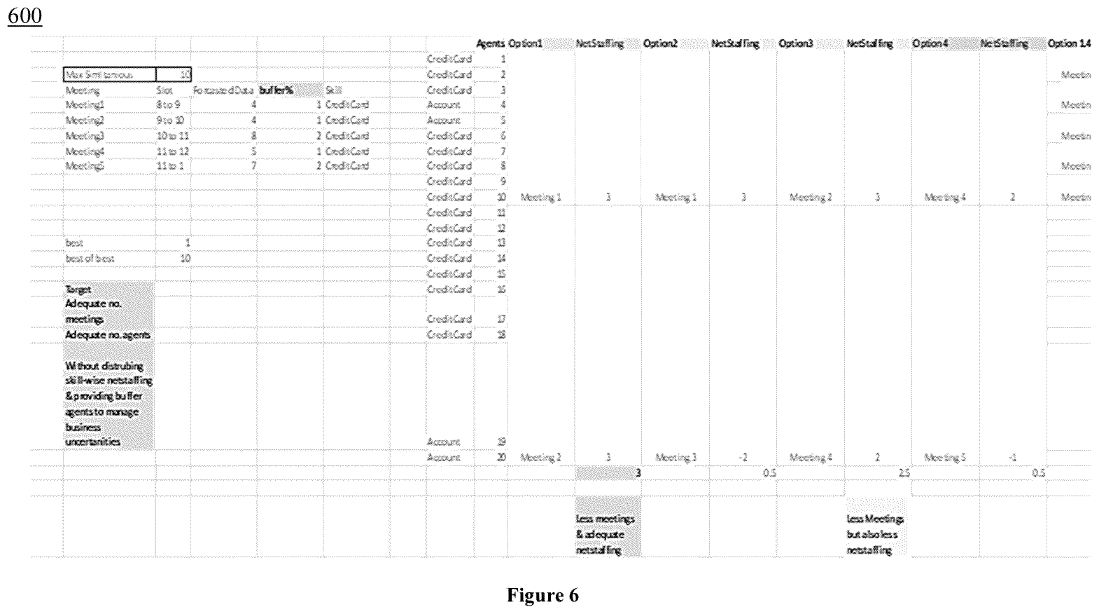

FIG. 6 shows a table 600 with several options of numbers of multi-session meeting, in accordance with some embodiments of the present disclosure.

According to some embodiments of the present disclosure, for a multi session meeting based on credit card, i.e., agents having skill-type of providing service for customers as to credit card, when the multi-session meeting has been set to have maximum 10 agents simultaneously, i.e., maximum 10 agents in each meeting, and buffer-level for the skill-type credit card has been set to 20% the for a given open slot of 30 minutes, there is a requirement of 10 agents with credit_card_voice_english skill-type, there could be a possibility of additional requirements of 10% for the same skill-type making it a total of 11 agents. Based on a method, such as computer-implemented method 200 in FIGS. 2A-2C for optimizing a number of sessions of a multi-session meeting based on agents skill requirement during a time-range of scheduled work-shifts, in a cloud-based contact center a session for the multi-session meeting may be allocated for the given slot, agents may be added to the session, such that 11 agents are always available to serve the customers. Hence, when original requirement was of 10 agents, with buffer-level of 10% it became 11 agents, and the contact center is not understaffed for the critical skill-type credit_card_voice_english.

FIG. 7 illustrates a selection of an optimal number of multi-session meeting, in accordance with some embodiments of the present disclosure.

In case, for example, in a contact center there are 50 agents having a skill-type of fluent in Spanish and the net staffing data for a time range of scheduled work-shifts for the skill-type of fluent in Spanish is 40 agents, and there is a requirement for a multi-session meeting for all the 50 agents based on the skill-type fluent in Spanish, then when a meeting may be scheduled for 10 agents who are not accounted for by the forecasted net staffing data in a time-range of scheduled work-shifts, the contact center may run into a situation of being understaffed for agents having the skill-type of Spanish calls when the volume of calls requiring Spanish as a language may suddenly increase.

On the other hand, if 45 agents may remain and only 5 agents may be scheduled a meeting then the contact center may be overstaffed because the 5 extra agents are not needed when the net staffing data is 40 agents. Therefore, there is a need for a technical solution to find an optimal number of sessions of a multi-session meeting such that the contact center may not be understaffed in case of a sudden spike in incoming interactions, as shown by element 710 in a specified skill type and not overstaffed, as shown by element 730.

According to some embodiments of the present disclosure, a computer-implemented method for optimizing a number of sessions of a multi-session meeting based on agents skill requirement during a time-range of scheduled work-shifts, in a cloud-based contact center, such as computer-implemented method 200 in FIG. 2 may be implemented in a system such as, system 100A in FIG. 1A and system 100B in FIG. 1B to arrive in optimal net staffing and matching skill buffer-level, as shown in element 720.

According to some embodiments of the present disclosure, the process of the computer-implemented method 200 in FIG. 2 may iteratively allocate a total number of agents to an average of lower-bound number of sessions and upper-bound number of sessions by using the greedy algorithm and the round-robin method and then assess the allocation of the agents to the sessions, such that if the contact center is overstaffed after the allocation, then the number of sessions in the next iteration of binary search may be reduced by updating the upper-bound, e.g., decreasing the upper-bound to the average of the lower-bound and upper-bound, such that each session may include more agents, but if the contact center is understaffed after the allocation, then the number of sessions may be increased by updating the lower-bound, e.g., increasing the lower-bound to the average of the upper-bound and lower-bound, such that there are less agents in each session. Eventually, there may be a preconfigured percentage of the upper bound of the number of sessions, e.g., 29% and then the iteration of determining a number of sessions of the multi-session meeting based on agents skill requirement by calculating an average of the calculated lower-bound of sessions and the calculated upper-bound of sessions and then allocating the total number of agents, may stop.

According to some embodiments of the present disclosure, the recalculating of the upper-bound or the lower-bound, i.e., the binary search may be needed only in situations where the contact center is overstaffed or understaffed. The optimal number of sessions may be 29% of upper bound number of sessions.

According to some embodiments of the present disclosure, the iteration the includes the calculation of number of sessions for the multi-session meeting and the allocation may stop when an optimal number of sessions have been determined, for example, as shown by element 720. The optimal number of sessions of the multi-session meeting is when the buffer-level for the selected one or more skill-types and utilization of the time of the host of the multi-session meeting is balanced.

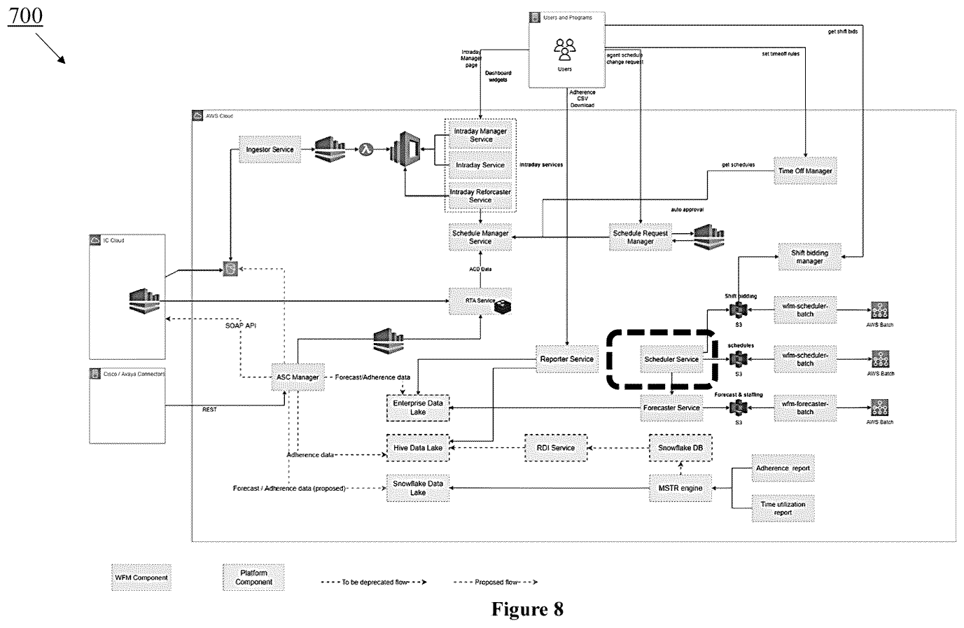

FIG. 8 shows components of a Workforce Management (WFM) scheduling system 800 and workflow, in accordance with some embodiments of the present disclosure.

According to some embodiments of the present disclosure, a WFM scheduling system 800, is a core application in the scheduling ecosystem. The schedule manager service, such as schedule manager MS 125a in FIG. 1A and such as, schedule manager MS 125b in FIG. 1B, handles the storage and retrieval of data of schedule of work-shifts, net staffing data, and configurations data that is required to generate schedules of work-shifts for agents, including daily rules, weekly rules, and activity codes.

According to some embodiments of the present disclosure, a meeting scheduler is a part of the schedule manager service which schedules the meeting by looking over the open slots of the agents for the specified duration. Other components of the WFM scheduling system 800 architecture include: (i) Schedule Requests Manager (SRM) that is managing agent-generated Schedule Change Requests (SCR)s; (ii) service of the SRM which handles adding/editing/getting/approving/declining of the SCRs; (iii) Real Time Adherence (RTA) manager; (iv) Intraday Manager Service (IMS); (v) intraday service: (vi) Intraday Re-Forecaster service; (vii) Ingestor service; (viii) time-off manager service; (ix) shift bidding manager service; (x) ASC Manager.

According to some embodiments of the present disclosure, upon a new or edit of an SCR calls may be submitted to the schedule rules automation MS validate Application Programming Interface (API) in order to validate the new or edited SCR against active auto approval rules. The SCR instructs other WFM components to carry out their tasks. The submitting of the calls may be disabled when there is a rule which auto decline the request. Then, when the new or edited SCR is validated, calls may be submitted to the service of the SRM for saving the agent requests as new schedules of work-shifts.

According to some embodiments of the present disclosure, the SRM may send notifications to managers when SCRs are created and may send notifications to agents as to approval or decline of SCRs. The data is stored in a data store such as Relational Database Service (RDS).

According to some embodiments of the present disclosure, the RTA manager is a service that handles the calculation of agents adherence status by comparing the actual activity of the agents that is received from the Automatic Call Distribution (ACD) system with an expected activity that has been scheduled for the agent that is received from the schedule-manager MS. The RTA manager may show that the agent is in adherence or out of adherence.

According to some embodiments of the present disclosure, the IMS may be implemented as a MS and may show all intraday metrics data, such as actual, forecasted, variance per one or more skill-types for a 24-hour time-range. The forecasted data may be compared with actual data and the variance may be derived to get understanding of whether the contact center is understaffed or overstaffed.

According to some embodiments of the present disclosure, the intraday service may handle intraday data and metrics that are part of the dashboard of the WFM system 800.

According to some embodiments of the present disclosure, the Intraday Re-Forecaster Service runs every preconfigured time e.g., 15 minutes, and it is triggered by a Cron, and starting two jobs: (i) Get Forecast data (AHT, ASA, Volume, SLA, Staffing) from schedule manager net staffing API and save it to ES; (ii) Calculate Reforecast data (AHT, ASA, Volume, SLA) for all tenants with reforecast toggle On, and save the results to a service such as Elasticsearch Service (ES). The forecast and reforecast data may be presented by the Intraday manager.

According to some embodiments of the present disclosure, the Ingestor service may be implemented by an Automated Call Distribution (ACD) ingestor MS which ingests IC ACD intraday data and metrics, that will be consumed by intraday and performance management system. The IC ACD ingestor MS may call an API to normalize and resolve the received data and send it to a kinesis stream, when triggered by the Cron every preconfigured time, e.g., spring com. Additionally, it may support receiving Intraday data from on-premise (on-prem) system of a tenant of the cloud based contact center, such as Cisco UCCX ACD, by monitoring a dedicated S3 bucket that the data is written to, normalize and resolve the received data (Data model) and send it to a kinesis stream.

According to some embodiments of the present disclosure, the time-off manager service may enable a user such as a WFM manager to define time-off rules, calculate time off balance for agents, and calculation API for automatic time off approval or semi-automatic approval.

According to some embodiments of the present disclosure, the shift bidding manager service may manage agents bids for specific work-shifts that are made available for bidding. The shift bidding feature allows the tenant supervisor to define a few different weekly work schedules and open it for bidding for the agents of a selected schedule unit.

According to some embodiments of the present disclosure, the Agent State Connector (ASC) manager may integrate between the WFM system that is implemented as a Software as a Service (SaaS) application and ACD nodes agents on-premise of each tenant. The ASC manager may send historical data. Intraday, and RTA of agents states events. The ACS manager may also integrate between the WFM system and lambdas that retrieve historical data using a contact center API and between the WFM system and User Interface (UI) to import/clean historical (csv format) data.

According to some embodiments of the present disclosure, in a contact center, a user such as the supervisor, may set up flexible meetings e.g., a plurality of sessions of a multi-session meeting for effective team collaboration via a UI, such as UI 115a in FIG. 1A and such as UI 115b in FIG. 1B. Optionally, a list of agents may be selected for the meeting and other parameters may be specified, such as maximum number of participants in each session, time range of scheduled work-shifts and one or more skill-types and a buffer-level for each skill-type of the one or more skill-types, as shown in FIG. 3.

According to some embodiments of the present disclosure, once all the parameters for the multi-session meeting have been entered via the UI, a webapp, such as webapp 110a in FIG. 1A and webapp 110b in FIG. 1B may process the parameters and forward them to the schedule manager MS. The schedule manager MS, such as schedule manager MS 125a in FIG. 1A, and such as schedule manager MS 125b in FIG. 1B may analyze the parameters and optimize the number of sessions of the multi-session meeting based on agents skill requirement during the time-range of scheduled work-shifts, in a cloud-based contact center.

According to some embodiments of the present disclosure, the schedule manager MS may schedule the sessions of the multi-session meeting in time slots of schedules of work-shifts of the agents. These time slots may be identified to accommodate the needs of the agents, taking into consideration their availability and preferences.

According to some embodiments of the present disclosure, after a time slot for each agent has been allocated the schedule manager MS may communicate this information, e.g., date and time of the time slot of each agent that participates in a session of the multi-session meeting, as well as duration of the session to an associated database, which may be a part of a database such as database of a plurality of agents 135a in FIG. 1A and such as database of a plurality of agents 135b in FIG. 1B.

According to some embodiments of the present disclosure, the schedule manager MS may update the existing schedules of work-shifts of each agent accordingly. The information related to the agents and their scheduled session may be communicated back to the web app such that the scheduled sessions may be visible to a supervisor to oversee the team's meeting engagements.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method for optimizing a number of sessions of a multi-session meeting based on agents skill requirement during a time-range of scheduled work-shifts, in a cloud-based contact center, said computer-implemented method comprising:
(i) receiving via a User Interface (UI) of a webapp a time-range of scheduled work-shifts, a maximum number of agents in each session of the multi-session meeting, one or more skill-types and a buffer-level for each skill-type of the one or more skill-types;
(ii) operating a schedule manager Microservice (MS) to provide a. scheduled work-shifts of agents in the time-range of scheduled work-shifts that include open slots from a database of a plurality of agents with a respective plurality of schedules of work-shifts thereon; and b. net staffing data of each skill-type of the received one or more skill-types in each open slot, in the scheduled work-shifts in the time-range of scheduled work-shifts;
(iii) determining a total number of agents in the time-range of scheduled work-shifts that include open slots;
(iv) calculating a lower-bound of sessions and an upper-bound of sessions;
(v) determining a number of sessions of the multi-session meeting based on agents skill requirement by calculating an average of the calculated lower-bound of sessions and the calculated upper-bound of sessions,
and
(vi) allocating the total number of agents in the time-range of scheduled work-shifts that include open slots to the determined number of sessions of the multi-session meeting based on agents skill requirement during the received time-range of scheduled work-shifts, and
wherein when the determined number of sessions of the multi-session meeting based on agents skill requirement is above a preconfigured percentage of the calculated upper-bound of sessions, decreasing the calculated upper-bound by a binary search algorithm and performing operations (v)-(vi), and
wherein when the determined number of sessions of the multi-session meeting based on agents skill requirement is below or equal to the preconfigured percentage of the calculated upper-bound of sessions increasing the calculated lower-bound by the binary search algorithm and performing operations (v)-(vi).

2. The computer-implemented method of claim 1, wherein said computer-implemented method is further comprising sending a notification to each agent in the total number of agents with session date and time and storing each updated schedule in the database of a plurality of agents with a respective plurality of schedules of work-shifts thereon.

3. The computer-implemented method of claim 1, wherein said computer-implemented method is further comprising updating each schedule of each agent of the determined total number of agents with session date and time.

4. The computer-implemented method of claim 1, wherein the calculating of lower-bound of sessions is operated by allocating for each open slot in the scheduled work-shifts in the time-range of scheduled work-shifts the received maximum number of agents in each session of the multi-session meeting and meeting the received buffer-level for each skill-type of the one or more skill-types based on net staffing data of each skill-type for the open slot, and wherein the calculating upper-bound of sessions is operated by allocating for each open slot in the scheduled work-shifts in the time-range of scheduled work-shifts a preconfigured percentage of the received maximum number of agents in each session of the multi-session meeting of skill-based agents and meeting the received buffer-level for each skill-type of the one or more skill-types based on net staffing data for the open slot.

5. The computer-implemented method of claim 1, wherein the determining of the total number of agents in the time-range of scheduled work-shifts that include open slots is based on preferences thereof.

6. The computer-implemented method of claim 1, wherein the allocating of the total number of agents to the determined number of sessions is operated by using a greedy algorithm and round-robin method for selecting each agent for each session in the number of sessions of the multi-session meeting.

7. The computer-implemented method of claim 1, wherein the allocating of the total number of agents in the time-range of scheduled work-shifts that include open slots to the determined number of sessions of the multi-session meeting based on agents skill requirement is random.

8. A computerized-system for optimizing a number of sessions of a multi-session meeting based on agents skill requirement during a time-range of scheduled work-shifts, in a cloud-based contact center, said computerized-system comprising:
a processor,
a memory including a database of a plurality of agents with a respective plurality of schedules of work-shifts thereon,
a User Interface (UI) of a webapp; and
a schedule manager Microservice (MS),
said processor is configured to:
(i) receive via a User Interface (UI) of a webapp a time-range of scheduled work-shifts, a maximum number of agents in each session of the multi-session meeting, one or more skill-types and a buffer-level for each skill-type of the one or more skill-types;
(ii) operate a schedule manager Microservice (MS) to provide a. scheduled work-shifts of agents in the time-range of scheduled work-shifts that include open slots from a database of a plurality of agents with a respective plurality of schedules of work-shifts thereon; and b. net staffing data of each skill-type of the received one or more skill-types in each open slot, in the scheduled work-shifts in the time-range of scheduled work-shifts;
(iii) determine a total number of agents in the time-range of scheduled work-shifts that include open slots;
(iv) calculate a lower-bound of sessions and an upper-bound of sessions;
(v) determine a number of sessions of the multi-session meeting based on agents skill requirement by calculating an average of the calculated lower-bound of sessions and the calculated upper-bound of sessions; and
(vi) allocate the total number of agents in the time-range of scheduled work-shifts that include open slots to the determined number of sessions of the multi-session meeting based on agents skill requirement, during the received time-range of scheduled work-shifts, and
wherein when the determined number of sessions of the multi-session meeting based on agents skill requirement is above a preconfigured percentage of the calculated upper-bound of sessions, decreasing the calculated upper-bound by a binary search algorithm and performing operation (v)-(vi), and
wherein when the determined number of sessions of the multi-session meeting based on agents skill requirement is below or equal to the preconfigured percentage of the calculated upper-bound of sessions increasing the calculated lower-bound by the binary search algorithm and performing operation (v)-(vi).
